(19) United States
(12) Patent Application Publication
(10) Pub. No.: US 2025/0014787 A1
(43) Pub. Date: Jan. 9, 2025

(54) SHUNT RESISTOR AND METHOD OF MANUFACTURING SHUNT RESISTOR

(71) Applicant: ROHM CO., LTD., Kyoto-shi (JP)

(72) Inventor: Kentaro NAKA, Kyoto-shi (JP)

(21) Appl. No.: 18/896,065

(22) Filed: Sep. 25, 2024

Related U.S. Application Data
(63) Continuation of application No. PCT/JP2023/007058, filed on Feb. 27, 2023.

(30) Foreign Application Priority Data
Mar. 29, 2022 (JP) 2022-053379

(51) Int. Cl. H01C 1/148; H01C 7/13; H01C 17/245

(52) U.S. Cl. CPC H01C 1/148; H01C 7/13; H01C 17/245

(57) ABSTRACT

A shunt resistor includes: a resistive element; and a first terminal portion and a second terminal portion. The resistive element has a first end and a second end in a second direction orthogonal to a first direction that is a thickness direction of the resistive element, the second end being an end opposite to the first end, and the resistive element has a third end and a fourth end in a third direction orthogonal to the first direction and the second direction, the fourth end being an end opposite to the third end. The first terminal portion and the second terminal portion are joined to the first end and the second end, respectively.

### TECHNICAL FIELD

The present disclosure relates to a shunt resistor and a method of manufacturing the shunt resistor.

### BACKGROUND ART

For example, U.S. Pat. No. 5,999,085 (PTL 1) describes a resistor. The resistor described in PTL 1 includes a resistive plate, a first pad, and a second pad. The resistive plate has a rectangular shape when viewed in a plan view. The resistive plate has a first end and a second end in a second direction orthogonal to a first direction that is a thickness direction of the resistive plate, the second end being an end opposite to the first end. The resistive plate has a third end and a fourth end in a second direction orthogonal to the first direction and the second direction, the fourth end being an end opposite to the third end. A first slit is formed in the fourth end.

The first pad and the second pad are joined to the first end and the second end. Each of the first pad and the second pad has a fifth end and sixth end, the fifth end being an end on the resistive plate side, the sixth end being an end opposite to the fifth end. A second slit extending along the second direction toward the fifth end is formed in the sixth end.

Each of the first pad and the second pad is divided into a current pad and a sense pad by the second slit. By measuring a voltage between the sense pad of the first pad and the sense pad of the second pad, a current flowing through the resistor described in PTL 1 is measured. That is, the resistor described in PTL 1 is a shunt resistor. The position of the second slit in the third direction is located on the third end side with respect to the center of the resistive plate in the third direction.

### CITATION LIST

### Patent Literature

PTL 1: U.S. Pat. No. 5,999,085

### BRIEF DESCRIPTION OF DRAWINGS

FIG. 1 is a perspective view of a shunt resistor 100.

FIG. 2 is a plan view of shunt resistor 100.

FIG. 3 is a bottom view of shunt resistor 100.

FIG. 4 is a front view of shunt resistor 100.

FIG. 5 is a flowchart of manufacturing of shunt resistor 100.

FIG. 6 is a perspective view illustrating a welding step S12.

FIG. 7 is a perspective view illustrating a punching step S131.

FIG. 8 is a perspective view illustrating a bending step S132.

FIG. 9 is a perspective view illustrating a slit forming step S14.

FIG. 10 is a perspective view illustrating a trimming step S2.

FIG. 11 is a perspective view illustrating a slit forming step S14 and a trimming step S2 according to a modification.

FIG. 12 is a perspective view of a shunt resistor 100A.

FIG. 13 is a graph showing a relation between a length of a first slit 10e and each of a surface temperature of shunt resistor 100 and a surface temperature of shunt resistor 100A.

FIG. 14 is a graph showing a relation between the length of first slit 10e and each of a temperature coefficient of resistance of shunt resistor 100 and a temperature coefficient of resistance of shunt resistor 100A.

FIG. 15 is a graph showing a relation between a length of a second slit 20c and the temperature coefficient of resistance of shunt resistor 100.

FIG. 16 is a front view of a shunt resistor 100B.

### DESCRIPTION OF EMBODIMENTS

Details of embodiments of the present disclosure will be described with reference to figures. In the below-described figures, the same or corresponding portions are denoted by the same reference characters and the same explanation will not be described repeatedly.

### First Embodiment

Hereinafter, a shunt resistor (shunt resistor 100) according to a first embodiment will be described.

### <Configuration of Shunt Resistor 100>

Hereinafter, a configuration of shunt resistor 100 will be described.

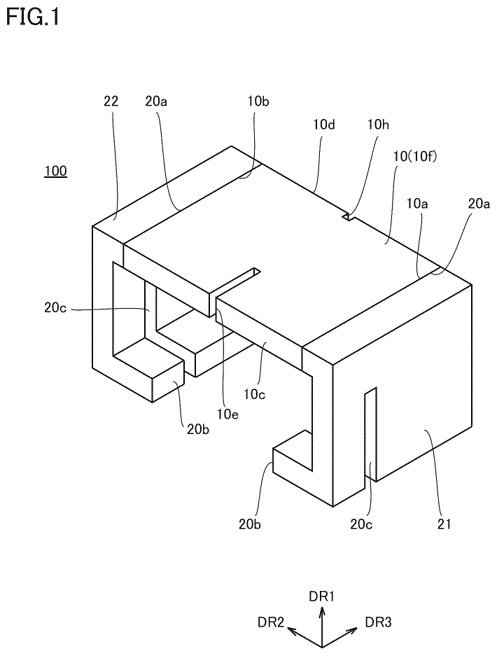

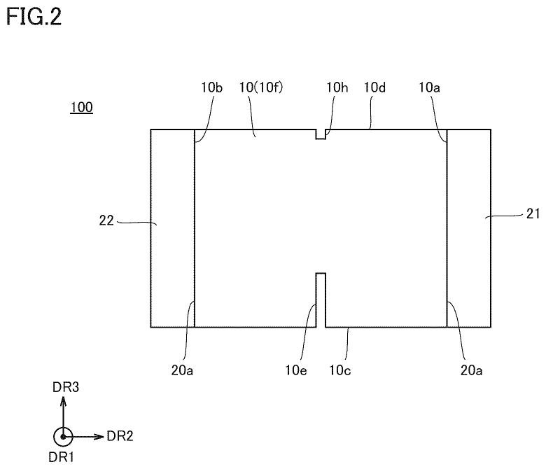

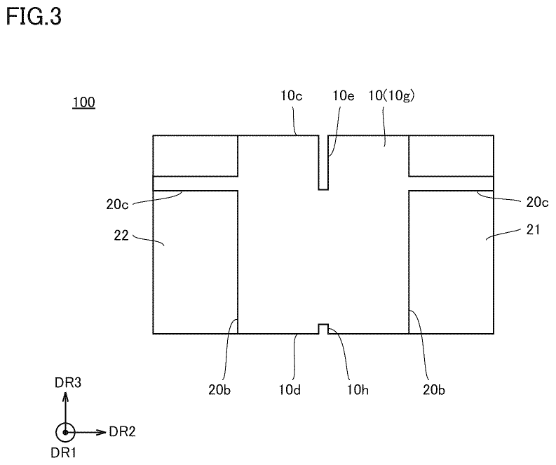

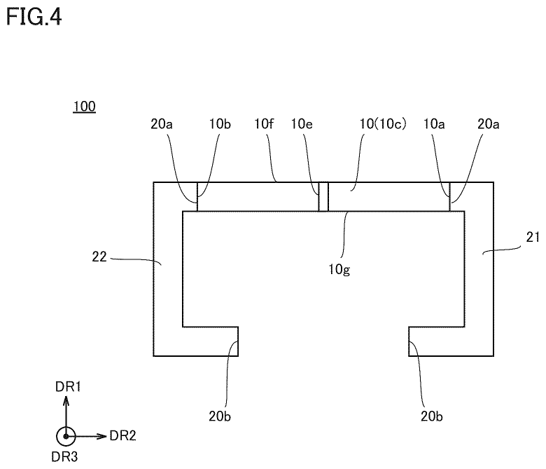

FIG. 1 is a perspective view of shunt resistor 100. FIG. 2 is a plan view of shunt resistor 100. FIG. 3 is a bottom view of shunt resistor 100. FIG. 4 is a front view of shunt resistor 100. As shown in FIGS. 1 to 4, shunt resistor 100 is a shunt resistor with four terminals. Shunt resistor 100 includes a resistive element 10, a first terminal portion 21, and a second terminal portion 22.

Resistive element 10 has a flat plate shape. A thickness direction of resistive element 10 is defined as a first direction DR1. A direction orthogonal to first direction DR1 is defined as a second direction DR2. A direction orthogonal to first direction DR1 and second direction DR2 is defined as a third direction DR3. Resistive element 10 has, for example, a rectangular shape when viewed in a plan view.

Resistive element 10 has a first end 10a and a second end 10b. First end 10a and second end 10b are both ends of resistive element 10 in second direction DR2. Second end 10b is an end opposite to first end 10a. Resistive element 10 has a third end 10c and a fourth end 10d. Third end 10c and fourth end 10d are both ends of resistive element 10 in third direction DR3. Fourth end 10d is an end opposite to third end 10c.

A first slit 10e is formed in third end 10c. First slit 10e extends, for example, along third direction DR3 toward fourth end 10d. First slit 10e extends through resistive element 10 along first direction DR1.

Resistive element 10 is composed of a conductor. Resistive element 10 is composed of, for example, Zeranin (registered trademark, CuMn7Sn), CuMn3, Manganin (registered trademark, CuMn12Ni), NiCrAl, or the like. However, resistive element 10 may be composed of a material other than these materials. The constituent material of resistive element 10 may be appropriately selected in accordance with required characteristics such as a specific resistance and a temperature coefficient of resistance. The thickness of resistive element 10 is preferably 0.4 mm or more. It should be noted that since first terminal portion 21 and second terminal portion 22 need to be thick when resistive element 10 is made thick, the thickness of resistive element 10 is preferably 0.6 mm or less in consideration of processability of each of first terminal portion 21 and second terminal portion 22.

First terminal portion 21 is joined to first end 10a. Second terminal portion 22 is joined to second end 10b. Each of first terminal portion 21 and second terminal portion 22 is joined to resistive element 10 by welding, for example. Each of first terminal portion 21 and second terminal portion 22 has a fifth end 20a and a sixth end 20b. Fifth end 20a is an end on the resistive element 10 side. Sixth end 20b is an end opposite to fifth end 20a. A second slit 20c is formed in each of first terminal portion 21 and second terminal portion 22. Second slit 20c extends through first terminal portion 21 (second terminal portion 22) along the thickness direction thereof. Each of the width of first terminal portion 21 in third direction DR3 and the width of second terminal portion 22 in third direction DR3 is equal to the width of resistive element 10 in third direction DR3, for example.

The position of second slit 20c in third direction DR3 is located on the third end 10c side with respect to the center of resistive element 10 in third direction DR3. That is, the width of a portion of first terminal portion 21 (second terminal portion 22) on one side (upper side in FIG. 3) with respect to second slit 20c in third direction DR3 is smaller than the width of a portion of first terminal portion 21 (second terminal portion 22) on the other side (lower side in FIG. 3) with respect to second slit 20c in third direction DR3. The portion of first terminal portion 21 (second terminal portion 22) on the one side with respect to second slit 20c in third direction DR3 is a sense terminal of first terminal portion 21 (second terminal portion 22). In shunt resistor 100, a value of current flowing through shunt resistor 100 is detected based on a value of voltage between the sense terminal of first terminal portion 21 and the sense terminal of second terminal portion 22.

The position of the tip of first slit 10e in third direction DR3 preferably overlaps with the position of second slit 20c in third direction DR3. The position of the tip of first slit 10e in third direction DR3 may be close to fourth end 10d with respect to the position of second slit 20c in third direction DR3. Each of first terminal portion 21 and second terminal portion 22 is composed of a conductor. Each of first terminal portion 21 and second terminal portion 22 is composed of, for example, copper or a copper alloy.

Resistive element 10 has a first surface 10f and a second surface 10g. First surface 10f and second surface 10g are end surfaces of resistive element 10 in first direction DR1. Second surface 10g is a surface opposite to first surface 10f. Each of first terminal portion 21 and second terminal portion 22 is bent inward such that sixth end 20b of first terminal portion 21 and sixth end 20b of second terminal portion 22 face each other with a space being interposed therebetween in second direction DR2. It should be noted that sixth end 20b of first terminal portion 21 and sixth end 20b of second terminal portion 22 face second surface 10g with a space being interposed therebetween in first direction DR1.

A third slit 10h may be formed in fourth end 10d. Third slit 10h extends, for example, along third direction DR3 toward third end 10c. The length of third slit 10h in third direction DR3 is smaller than the length of first slit 10e in third direction DR3.

A temperature coefficient of resistance (TCR) of shunt resistor 100 is preferably −50 ppm/° C. or more and 50 ppm/° C. or less. It should be noted that the temperature coefficient of resistance of shunt resistor 100 is measured using, for example, RM3543 from HIOKI E.E. CORPORATION. The temperature coefficient of resistance of shunt resistor 100 is measured with shunt resistor 100 being mounted on a substrate, for example. For example, the substrate has: a base material composed of glass epoxy having a thickness of 1.6 mm; and a copper foil disposed on the base material and having a thickness of 35 μm.

### <Method of Manufacturing Shunt Resistor 100>

Hereinafter, a method of manufacturing shunt resistor 100 will be described.

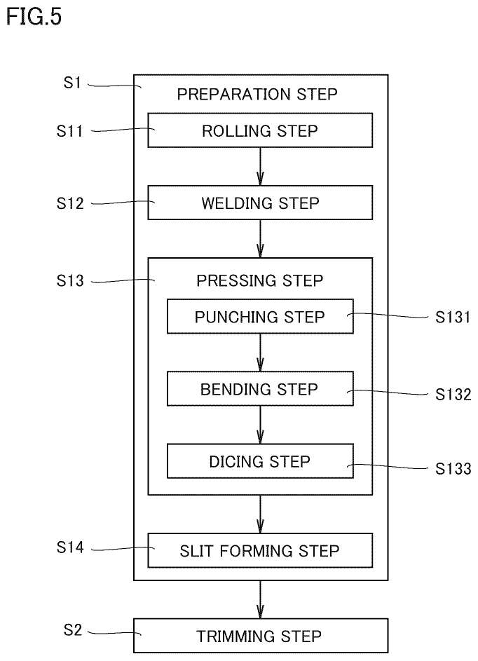

FIG. 5 is a flowchart of manufacturing of shunt resistor 100. As shown in FIG. 5, the method of manufacturing shunt resistor 100 includes a preparation step S1 and a trimming step S2. Trimming step S2 is performed after preparation step S1.

In preparation step S1, a plurality of shunt resistors 100 are prepared. It should be noted that no third slit 10h is formed in each of the plurality of shunt resistors 100 prepared in preparation step S1. Preparation step S1 has a rolling step S11, a welding step S12, a pressing step S13, and a slit forming step S14. Welding step S12 is performed after rolling step S11. Pressing step S13 is performed after welding step S12. Slit forming step S14 is performed after pressing step S13.

Pressing step S13 includes a punching step S131, a bending step S132, and a dicing step S133. Bending step S132 is performed after punching step S131. Dicing step S133 is performed after bending step S132.

In rolling step S11, a first plate member 11, a second plate member 23, and a third plate member 24 are subjected to rolling, thereby adjusting the thicknesses of first plate member 11, second plate member 23, and third plate member 24. On this occasion, warpage and curve of each of first plate member 11, second plate member 23, and third plate member 24 are also corrected. First plate member 11 is a plate member composed of the same material as that of resistive element 10, second plate member 23 is a plate member composed of the same material as that of first terminal portion 21, and third plate member 24 is a plate member composed of the same material as that of second terminal portion 22. The long-side direction of each of first plate member 11, second plate member 23, and third plate member 24 is along third direction DR3.

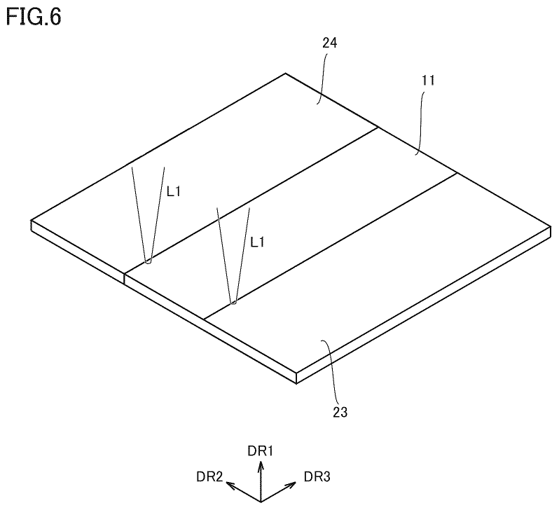

FIG. 6 is a perspective view illustrating welding step S12. As shown in FIG. 6, in welding step S12, second plate member 23 and third plate member 24 are welded to first plate member 11. In welding step S12, first, first plate member 11, second plate member 23, and third plate member 24 are arranged along second direction DR2. On this occasion, first plate member 11 is sandwiched between second plate member 23 and third plate member 24.

Second, a boundary between first plate member 11 and second plate member 23 and a boundary between first plate member 11 and third plate member 24 are welded. This welding is performed, for example, by applying laser L1 along the boundary between first plate member 11 and second plate member 23 and the boundary between first plate member 11 and third plate member 24.

In pressing step S13, first plate member 11, second plate member 23, and third plate member 24 are subjected to a pressing process.

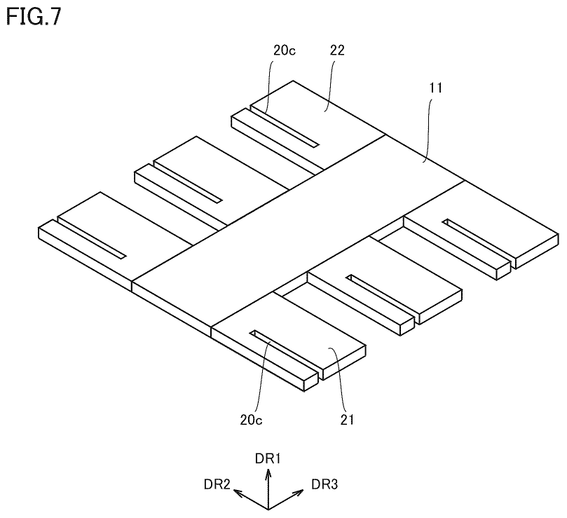

FIG. 7 is a perspective view illustrating punching step S131. As shown in FIG. 7, in punching step S131, first, a plurality of second slits 20c are formed in second plate member 23 and third plate member 24. The plurality of second slits 20c are formed side by side at intervals in third direction DR3. Second, second plate member 23 is divided into a plurality of first terminal portions 21, and third plate member 24 is divided into a plurality of second terminal portions 22.

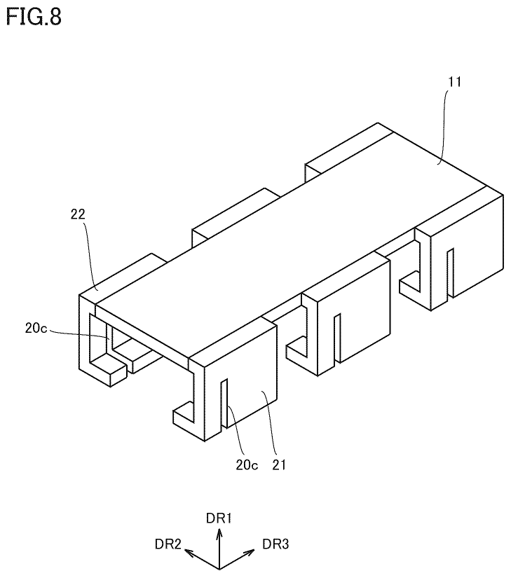

FIG. 8 is a perspective view illustrating bending step S132. As shown in FIG. 8, in bending step S132, each first terminal portion 21 and each second terminal portion 22 are bent inward such that sixth end 20b of first terminal portion 21 and sixth end 20b of second terminal portion 22 face each other with a space being interposed therebetween in second direction DR2. In dicing step S133, first plate member 11 is cut, thereby obtaining a plurality of shunt resistors 100.

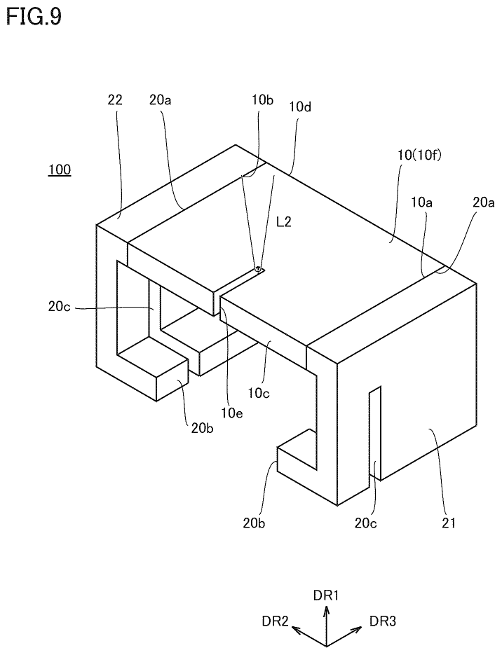

FIG. 9 is a perspective view illustrating slit forming step S14. As shown in FIG. 9, in slit forming step S14, first slit 10e is formed in third end 10c of each of the plurality of shunt resistors 100. First slit 10e is formed, for example, by applying laser L2 to resistive element 10. First slits 10e of the plurality of shunt resistors 100 are formed to have the same length in third direction DR3.

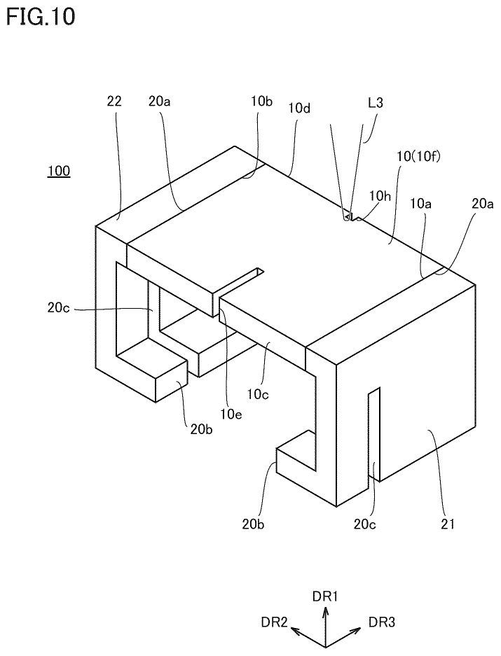

FIG. 10 is a perspective view illustrating trimming step S2. As shown in FIG. 10, in trimming step S2, third slit 10h is formed in fourth end 10d of each of the plurality of shunt resistors 100, thereby adjusting electrical resistance values of the plurality of shunt resistors 100. The lengths of third slits 10h of the plurality of shunt resistors 100 in third direction DR3 may be different from each other. Each of third slits 10h is formed, for example, by applying laser L3 to resistive element 10. In this way, shunt resistor 100 having the structure shown in FIGS. 1 to 4 is manufactured. It should be noted that after trimming step S2 is performed, cleaning or anticorrosive treatment may be performed onto a surface of shunt resistor 100.

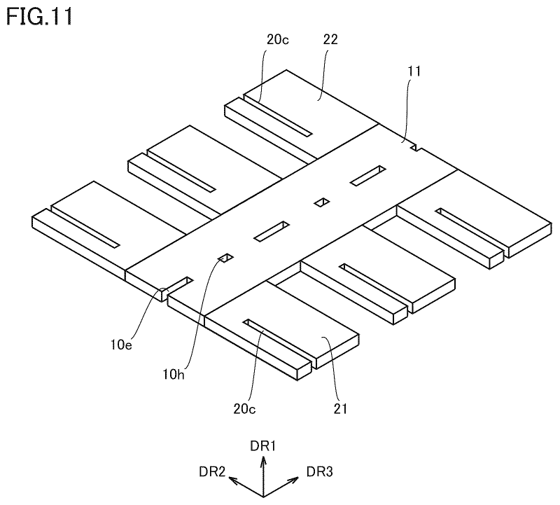

FIG. 11 is a perspective view illustrating a slit forming step S14 and a trimming step S2 according to a modification. As shown in FIG. 11, slit forming step S14 and trimming step S2 may be performed through a pressing process between punching step S131 and bending step S132. Although not shown in the figure, slit forming step S14 may be performed through a pressing process between punching step S131 and bending step S132.

### <Effect of Shunt Resistor 100>

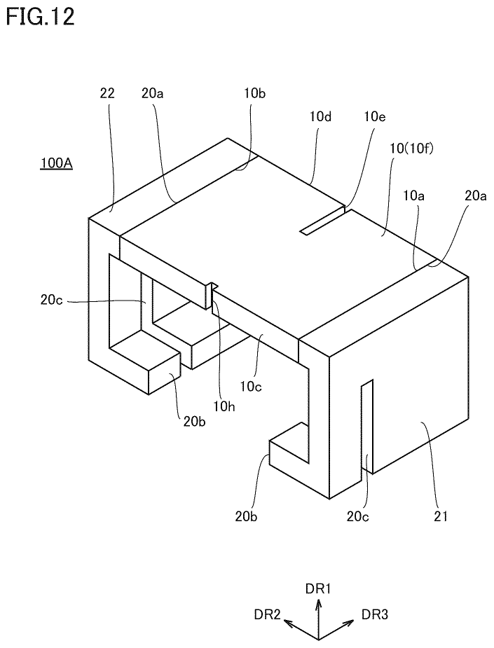

Hereinafter, an effect of shunt resistor 100 will be described in comparison with a shunt resistor according to a comparative example. The shunt resistor according to the comparative example is referred to as a shunt resistor 100A. FIG. 12 is a perspective view of shunt resistor 100A. As shown in FIG. 12, in shunt resistor 100A, first slit 10e is formed in fourth end 10d, and third slit 10h is formed in third end 10c. Apart from this point, the configuration of shunt resistor 100A is the same as the configuration of shunt resistor 100.

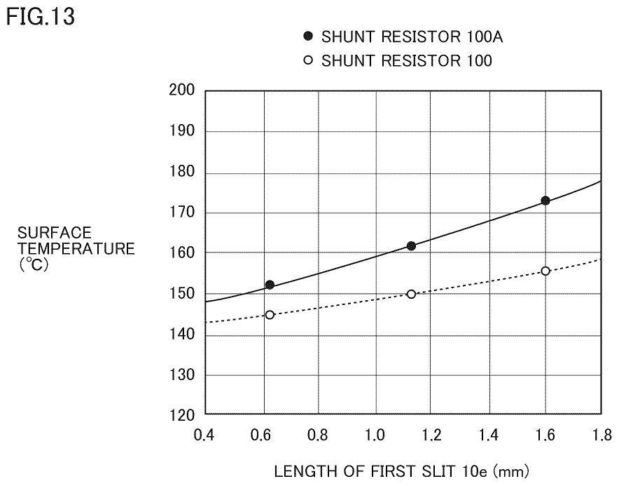

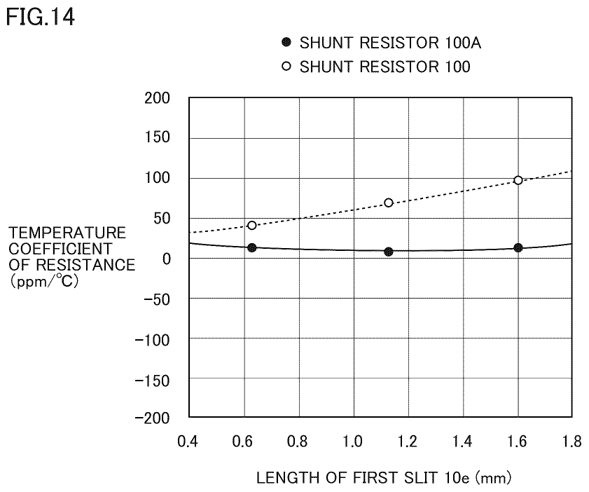

FIG. 13 is a graph showing a relation between the length of first slit 10e and each of a surface temperature of shunt resistor 100 and a surface temperature of shunt resistor 100A. The graph of FIG. 13 is created based on data measured in a state in which power of 5 W is applied to each of shunt resistor 100 and shunt resistor 100A. FIG. 14 is a graph showing a relation between the length of first slit 10e and each of a temperature coefficient of resistance of shunt resistor 100 and a temperature coefficient of resistance of shunt resistor 100A. As shown in FIGS. 13 and 14, behaviors of the heat generation amount and the temperature coefficient of resistance of the shunt resistor are different between the case where first slit 10e is formed in third end 10c and the case where first slit 10e is formed in fourth end 10d.

More specifically, in shunt resistor 100A in which first slit 10e is formed in fourth end 10d, the temperature coefficient of resistance is less likely to be large when the length of first slit 10e is large, but the heat generation amount is greatly increased when the length of first slit 10e is large. On the other hand, in shunt resistor 100 in which first slit 10e is formed in third end 10c, the heat generation amount is less likely to be increased when the length of first slit 10e is large, but the temperature coefficient of resistance is greatly increased when the length of first slit 10e is large.

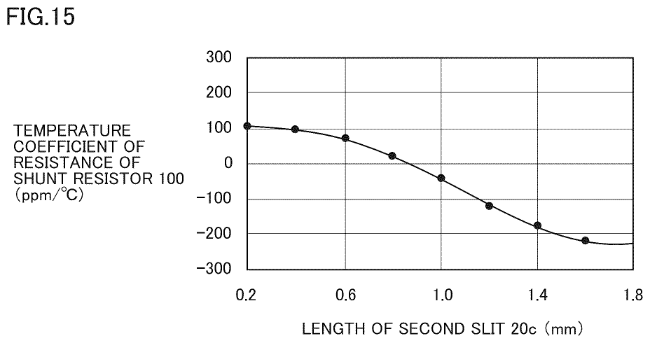

FIG. 15 is a graph showing a relation between the length of second slit 20c and the temperature coefficient of resistance of shunt resistor 100. The graph of FIG. 15 was found by a CAE (Computer Aided Engineering) analysis. As shown in FIG. 15, the temperature coefficient of resistance of shunt resistor 100 is changed according to the length of second slit 20c. Therefore, in shunt resistor 100, the increase of the temperature coefficient of resistance in response to the increase of the length of first slit 10e can be cancelled by adjusting the length of second slit 20c. Therefore, according to shunt resistor 100, it is possible to suppress the increase of the temperature coefficient of resistance and the increase of the heat generation amount.

In shunt resistor 100A, third slit 10h is formed in third end 10c so as to adjust the electrical resistance value. Therefore, in shunt resistor 100A, an amount of increase of the temperature coefficient of resistance in response to the adjustment of the electrical resistance value is large. Similarly, in shunt resistor 100, third slit 10h is also formed so as to adjust the electrical resistance value. However, since third slit 10h is formed in fourth end 10d in shunt resistor 100, the amount of increase of the temperature coefficient of resistance in response to the formation of third slit 10h is small. Thus, in shunt resistor 100, the increase of the temperature coefficient of resistance can be suppressed even when the electrical resistance value is adjusted by forming third slit 10h.

The electrical resistance value of resistive element 10 is calculated as follows: the specific resistance×the width of resistive element 10/(the thickness of resistive element 10×the length of resistive element 10 in second direction DR2). Therefore, the electrical resistance value of resistive element 10 can also be increased by reducing the thickness of resistive element 10 without forming first slit 10e. However, when the thickness of resistive element 10 is made small, the heat generation amount in resistive element 10 is increased. Since the thickness of resistive element 10 is preferably 0.4 mm or more in shunt resistor 100, the heat generation amount of shunt resistor 100 is suppressed also from this point of view.

In shunt resistor 100, when first terminal portion 21 and second terminal portion 22 are bent inward such that sixth end 20b of first terminal portion 21 and sixth end 20b of second terminal portion 22 face each other with a space being interposed therebetween, an area occupied by shunt resistor 100 when viewed in a plan view can be small.

### Second Embodiment

Hereinafter, a shunt resistor (shunt resistor 100B) according to a second embodiment will be described. Here, a difference from shunt resistor 100 will be mainly described and the same explanation will not be described repeatedly.

### <Configuration of Shunt Resistor 100B>

Hereinafter, a configuration of shunt resistor 100B will be described.

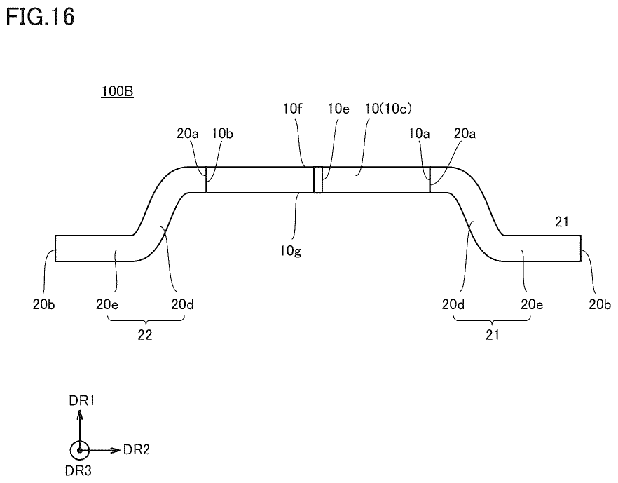

FIG. 16 is a front view of shunt resistor 100B. As shown in FIG. 16, shunt resistor 100B has resistive element 10, first terminal portion 21, and second terminal portion 22. Although not shown in FIG. 16, first slit 10e is formed in third end 10c, second slit 20c is formed in sixth end 20b, and third slit 10h is formed in fourth end 10d. Regarding these points, the configuration of shunt resistor 100B is the same as the configuration of shunt resistor 100.

In shunt resistor 100B, each of first terminal portion 21 and second terminal portion 22 has a first portion 20d and a second portion 20e. First portion 20d is a portion of first terminal portion 21 (second terminal portion 22) that is joined to resistive element 10 and that includes fifth end 20a. Second portion 20e is a portion of first terminal portion 21 (second terminal portion 22) that is connected to first portion 20d from a side opposite to resistive element 10 and that includes sixth end 20b.

First portion 20d is bent such that sixth end 20b is separated from resistive element 10 with respect to fifth end 20a in first direction DR1. In shunt resistor 100B, sixth end 20b of first terminal portion 21 and sixth end 20b of second terminal portion 22 are located at both ends of shunt resistor 100B in second direction DR2, respectively. That is, in shunt resistor 100B, first terminal portion 21 and second terminal portion 22 are bent outward. Regarding these points, the configuration of shunt resistor 100B is different from the configuration of shunt resistor 100.

### <Effect of Shunt Resistor 100B>

Hereinafter, an effect of shunt resistor 100B will be described.

Since first terminal portion 21 and second terminal portion 22 are bent outward in shunt resistor 100B, the height thereof can be lower than that of shunt resistor 100 in which first terminal portion 21 and second terminal portion 22 are bent inward.

When a rotary blade is brought into contact with resistive element 10 so as to form first slit 10e and third slit 10h in shunt resistor 100, the rotary blade may come into contact with first terminal portion 21 and second terminal portion 22 each bent inward, with the result that it is difficult to form first slit 10e and third slit 10h by a cutting process using the rotary blade.

On the other hand, since first terminal portion 21 and second terminal portion 22 are bent outward in shunt resistor 100B, first slit 10e and third slit 10h can be formed by the rotary blade without coming into contact with first terminal portion 21 and second terminal portion 22. Thus, according to shunt resistor 100B, a degree of freedom of processing in slit forming step S14 and trimming step S2 can be increased as compared with shunt resistor 100.

Although the embodiments of the present disclosure have been described above, the above-described embodiments can be modified in various manners. Further, the scope of the present invention is not limited to the above-described embodiments. The scope of the present invention is defined by the terms of the claims, and is intended to include any modifications within the scope and meaning equivalent to the terms of the claims.

### REFERENCE SIGNS LIST

10: resistive element; 10a: first end; 10b: second end; 10c: third end; 10d: fourth end; 10e: first slit; 10f: first surface; 10g: second surface; 10h: third slit; 11: first plate member; 20a: fifth end; 20b: sixth end; 20c: second slit; 20d: first portion; 20e: second portion; 21: first terminal portion; 22: second terminal portion; 23: second plate member; 24: third plate member; 100: shunt resistor; 100A: shunt resistor; 100B: shunt resistor; DR1: first direction; DR2: second direction; DR3: third direction; L1, L2, L3: laser; S1: preparation step; S11: rolling step; S12: welding step; S13: pressing step; S131: punching step; S132: step; S133: dicing step; S14: slit forming step; S2: trimming step.

1. A shunt resistor comprising:
a resistive element; and
a first terminal portion and a second terminal portion, wherein
the resistive element has a first end and a second end in a second direction orthogonal to a first direction that is a thickness direction of the resistive element, the second end being an end opposite to the first end, and the resistive element has a third end and a fourth end in a third direction orthogonal to the first direction and the second direction, the fourth end being an end opposite to the third end,
the first terminal portion and the second terminal portion are joined to the first end and the second end, respectively,
a first slit is formed in the third end,
each of the first terminal portion and the second terminal portion has a fifth end and a sixth end, the fifth end being an end on the resistive element side, the sixth end being an end opposite to the fifth end,
a second slit extending along the second direction toward the fifth end is formed in the sixth end, and
a position of the second slit in the third direction is close to the third end with respect to a center of the resistive element in the third direction.

2. The shunt resistor according to claim 1, wherein a position of a tip of the first slit in the third direction overlaps with the position of the second slit in the third direction or is located on the fourth end side with respect to the position of the second slit in the third direction.

3. The shunt resistor according to claim 1, wherein
a third slit extending along the third direction toward the third end is formed in the fourth end, and
a length of the third slit in the third direction is smaller than a length of the first slit in the third direction.

4. The shunt resistor according to claim 1, wherein a thickness of the resistive element is 0.4 mm or more.

5. The shunt resistor according to claim 1, wherein each of the first terminal portion and the second terminal portion is bent inward such that the sixth end of the first terminal portion and the sixth end of the second terminal portion face each other with a space being interposed between the sixth end of the first terminal portion and the sixth end of the second terminal portion in the second direction.

6. The shunt resistor according to claim 1, wherein
each of the first terminal portion and the second terminal portion has a first portion and a second portion, the first portion being joined to the resistive element, the first portion including the fifth end, the second portion being connected to the first portion from a side opposite to the resistive element, the second portion including the sixth end, and
the first portion is bent such that the sixth end is separated from the resistive element with respect to the fifth end in the first direction and the sixth end is located at an end of the shunt resistor in the first direction.

7. The shunt resistor according to claim 1, wherein a temperature coefficient of resistance of the shunt resistor is-50 ppm/° C. or more and 50 ppm/° C. or less.

8. A method of manufacturing a shunt resistor, the method comprising:
preparing a plurality of shunt resistors; and
performing trimming, wherein
each of the plurality of shunt resistors includes a resistive element, a first terminal portion, and a second terminal portion,
the resistive element has a first end and a second end in a second direction orthogonal to a first direction that is a thickness direction of the resistive element, the second end being an end opposite to the first end, and the resistive element has a third end and a fourth end in a third direction orthogonal to the first direction and the second direction, the fourth end being an end opposite to the third end,
the first terminal portion and the second terminal portion are joined to the first end and the second end, respectively,
a first slit is formed in the third end,
each of the first terminal portion and the second terminal portion has a fifth end and a sixth end, the fifth end being an end on the resistive element side, the sixth end being an end opposite to the fifth end,
a second slit extending along the second direction toward the fifth end is formed in the sixth end,
a position of the second slit in the third direction is close to the third end with respect to a center of the resistive element in the third direction,
in the plurality of shunt resistors, respective lengths of the first slits in the second direction are the same,
in the performing trimming, a third slit is formed in the fourth end of each of the plurality of shunt resistors so as to adjust an electrical resistance value of each of the plurality of shunt resistors, and
a length of the third slit in the third direction is smaller than a length of the first slit in the third direction.
